(19) United States
(12) Patent Application Publication
(10) Pub. No.: US 2026/0100060 A1
(43) Pub. Date: Apr. 9, 2026

(54) GAZE-BASED SENSOR DATA COMPRESSION FOR VEHICLE

(71) Applicant: FCA US LLC, Auburn Hills, MI (US)

(72) Inventors: Emily A. Robb, Auburn Hills, MI (US); Daniel Cashen, Auburn Hills, MI (US); Rajeev K. Tiwari, Auburn Hills, MI (US); Esaias Pech, Auburn Hills, MI (US); Andrew Averhart, Auburn Hills, MI (US)

(21) Appl. No.: 18/910,452

(22) Filed: Oct. 9, 2024

(51) Int. Cl. G06V 20/59; B60W 40/09; G06V 10/25; G06V 40/18

(52) U.S. Cl. CPC G06V 20/597; B60W 40/09; G06V 10/25; G06V 40/18; B60W 2420/403; B60W 2420/408

(57) ABSTRACT

A vehicle includes a sensor system including one or more individual sensors configured to capture sensor data, a driver camera configured to monitor a driver head position and a driver gaze vector indicating a direction of driver vision, and a data compression system including a computing device. The computing device is configured to perform operations including: receiving sensor data from each individual sensor, determining, by the driver camera, an instantaneous driver head position and driver gaze vector, determining, for each individual sensor, a region of interest (ROI) of the sensor data based on the instantaneous driver head position and driver gaze vector, and cropping the ROI for each individual sensor based on an intersection of the driver gaze vector with the determined ROI to thereby provide cropped sensor data with a reduced amount of sensor data from each individual sensor.

### FIELD

The present application relates generally to sensor data collection systems for vehicles and, more particularly, to systems and methods for compression of vehicle sensor data.

### BACKGROUND

Conventional vehicle data compression methodologies for trigger-based data collection from embedded devices, such as computer vision systems, typically utilize cropping and region-of-interest (ROI) selection based on either a fixed region of the field of view (FOV), or an adjustable FOV based on steering angle, or downscaling of the entire FOV. However, these solutions either miss or capture with unnecessarily low resolution, elements of the scene that impact the vehicle environment model, but have trajectories with high angular velocity and at the edge of the FOV or outside the steering angle defined FOV. Accordingly, while conventional systems do work well for their intended purpose, there exists an opportunity for improvement in the relevant art.

### SUMMARY

In one example aspect of the invention, a vehicle is provided. In one example implementation, the vehicle includes a sensor system including one or more individual sensors configured to capture sensor data, a driver camera configured to monitor a driver head position and a driver gaze vector indicating a direction of driver vision, and a data compression system including a computing device having one or more processors and a non-transitory computer-readable storage medium having a plurality of instructions stored thereon, which, when executed by the one or more processors, cause the one or more processors to perform operations. The operations include receiving sensor data from each individual sensor, determining, by the driver camera, an instantaneous driver head position and driver gaze vector, determining, for each individual sensor, a region of interest (ROI) of the sensor data based on the instantaneous driver head position and driver gaze vector, and cropping the ROI for each individual sensor based on an intersection of the driver gaze vector with the determined ROI to thereby provide cropped sensor data with a reduced amount of sensor data from each individual sensor.

In addition to the foregoing, the described vehicle may include one or more of the following features: wherein the intersection of the driver gaze vector with the determined ROI defines a center of the determined ROI, and cropping the ROI is based on a user-configurable data cropping size that is expanded by an error estimation; wherein the computing device further performs operations including transferring the cropped sensor data for each individual sensor to a rolling RAM buffer; identifying a data capture trigger event, and transferring the cropped sensor data for each individual sensor from the rolling RAM buffer to an onboard data storage device for further analysis of the data capture trigger event; and uploading the cropped sensor data from the onboard data storage device to a networked data center for further analysis of the data capture trigger event.

In addition to the foregoing, the described vehicle may include one or more of the following features: wherein the data capture trigger event is a driver takeover from an advanced driver assist system (ADAS) or an autonomous driving system; wherein the one or more individual sensors comprises each of one or more exterior cameras configured for machine vision functionality, one or more radar sensors, and one or more lidar sensors; and wherein the computing device further performs operations including correcting the sensor data from each individual sensor utilizing extrinsic and intrinsic calibration information; correcting sensor data time stamps from each individual sensor based on sensor latency estimates; and correcting sensor data time stamps from each individual sensor based on one or more signals from a vehicle motion module configured to detect vehicle motion.

In accordance with another example aspect of the invention, a method is provided for data compression in a vehicle having a sensor system including one or more individual sensors configured to capture sensor data, a driver camera configured to monitor a driver head position and a driver gaze vector indicating a direction of driver vision, and a data compression system including a computing device having one or more processors.

In one example implementation, the method includes receiving, at the computing device, sensor data from each individual sensor; determining, by the computing device and the driver camera, an instantaneous driver head position and driver gaze vector; determining, by the computing device, for each individual sensor, a region of interest (ROI) of the sensor data based on the instantaneous driver head position and driver gaze vector; and cropping, by the computing device, the ROI for each individual sensor based on an intersection of the driver gaze vector with the determined ROI to thereby provide cropped sensor data with a reduced amount of sensor data from each individual sensor.

In addition to the foregoing, the described method may include one or more of the following features: wherein the intersection of the driver gaze vector with the determined ROI defines a center of the determined ROI, and cropping the ROI is based on a user-configurable data cropping size that is expanded by an error estimation; transferring, by the computing device, the cropped sensor data for each individual sensor to a rolling RAM buffer; identifying a data capture trigger event, and transferring, by the computing device, the cropped sensor data for each individual sensor from the rolling RAM buffer to an onboard data storage device for further analysis of the data capture trigger event; and uploading, by the computing device, the cropped sensor data from the onboard data storage device to a networked data center for further analysis of the data capture trigger event.

In addition to the foregoing, the described method may include one or more of the following features: wherein the data capture trigger event is a driver takeover from an advanced driver assist system (ADAS) or an autonomous driving system; wherein the one or more individual sensors comprises each of one or more exterior cameras configured for machine vision functionality, one or more radar sensors, and one or more lidar sensors; correcting, by the computing device, the sensor data from each individual sensor utilizing extrinsic and intrinsic calibration information; correcting, by the computing device, sensor data time stamps from each individual sensor based on sensor latency estimates; and correcting, by the computing device, sensor data time stamps from each individual sensor based on one or more signals from a vehicle motion module configured to detect motion of the vehicle.

Further areas of applicability of the teachings of the present application will become apparent from the detailed description, claims and the drawings. It should be understood that the detailed description, including disclosed embodiments and drawings referenced therein, are merely exemplary in nature intended for purposes of illustration only and are not intended to limit the scope of the present application, its application or uses. Thus, variations that do not depart from the gist of the present application are intended to be within the scope of the present application.

### BRIEF DESCRIPTION OF DRAWINGS

FIG. 1 is a functional block diagram of a vehicle having a control system for vehicle data compression in accordance with the principles of the present disclosure;

FIG. 2 is a functional block diagram of the control system shown in FIG. 1, in accordance with the principles of the present disclosure;

FIG. 3 is a schematic diagram of an example gaze-based ROI compression algorithm of the control system shown in FIG. 2, in accordance with the principles of the present disclosure; and

FIG. 4 is a flow diagram of an example method of vehicle sensor data collection and compression in accordance with the principles of the present disclosure.

### DESCRIPTION

As previously discussed, conventional vehicle data compression methodologies for trigger-based data collection from embedded devices (e.g., computer vision systems) typically utilize cropping and region-of-interest (ROI) selection based on either a fixed region of the field of view (FOV), or an adjustable FOV based on steering angle, or downscaling of the entire FOV. However, these solutions either miss or capture with unnecessarily low resolution, elements of the scene that impact the vehicle environment model, but have trajectories with high angular velocity and at the edge of the FOV or outside the steering angle defined FOV.

Accordingly, the present application is generally directed to systems and methods for vehicle sensor data compression that incorporates an instantaneous driver gaze vector into ROI selection. In one example, the system utilizes interpretation of driver intent behind takeover request based on driver gaze pattern in the moments leading up to a driver takeover from, for example, an automatic driver assist system (ADAS) or autonomous driving system. The system utilizes transformation of the driver focus region into sensor coordinates for down-selection of the most relevant data for artificial intelligence (AI) perception algorithm training and validation.

In general, large amounts of high-quality camera data is required to develop high-performance AI computer vision (CV) algorithms. As such, camera data of specific situations where AI systems need to improve is of high value. Such valuable datasets are based on (i) the number of cameras that will be connected to high-performance embedded computers (HPCs), and (ii) the number of signals available to augment the camera datasets due to the signal aggregation within those HPCs. This data is then stored in a rolling buffer in RAM prior to being stored in Flash memory until it can be uploaded to a data center. RAM and Flash are some of the most expensive components of these HPCs.

In one example embodiment, the system optimizes the RAM and Flash required to store a given amount of valuable data for AI CV algorithm training, and it does so based on a simple algorithm with a small compute footprint, and without requiring the data to be streamed to the cloud (e.g., no upload cost, no cloud processing cost). The system compresses gaze data to facilitate lowering the processing load on the onboard computing equipment. This is critical for applications that require real-time processing of several data streams for tasks, such driver attention monitoring and intelligent vehicle control. Accordingly, the system utilizes the instantaneous driver gaze vector paired with video frames at the same timestamp, and extrinsic and intrinsic camera calibration information to identify and crop regions of video to be stored, while the remainder is discarded. Additionally, or alternatively, radar and/or lidar data may be cropped in the same manner only with extrinsic calibration information.

The system captures sensor data within the specific regions of the driving scene where the driver was looking prior to a Data Collection Triggering Event (e.g., a driver take-over request of an autonomous system). In this way, for example, the system can harvest insight from the driver regarding the reasons that they chose to take over vehicle control from the ADAS.

The system includes a data compression algorithm that incorporates an instantaneous driver gaze vector into (3D or 2D) ROI selection and cropping of video and sensor data in the previous rolling buffer time window to an event that triggers data collection. The system has sufficiently low latency (or accurately known latency) of the following signal types: (i) the Driver Gaze signal processing and propagation path to the HPC executing the compression algorithm, such that the size of ROI allocated to system spatial error is minimized (more efficient compression), and (ii) the camera, radar, and/or lidar sensor data streams from signal capture to presentation to a Data Collection Application.

The system is configured to calibrate (i) individual sensor extrinsic and intrinsic calibration information, and (ii) system-level extrinsic alignment enabling all sensor signals to be represented in a common vehicle coordinate system. As such, the system is equipped with a calibration function that utilizes sensor intrinsic and extrinsic calibration data to transform all sensor data into a common coordinate system. In one example, vehicle (ego) motion signals include inertial navigation system (INS) signals and odometry signals. The ego motion may be an algorithm that converts INS signals (e.g., accelerations in xyz and roll-pitch-yaw, including their rates of change) and wheel speed into vehicle ego motion (e.g., vehicle level velocity in xyz, and angular rates such as yaw rate, pitch rate, and roll rate). As such, the system utilizes the outputs of the ego motion algorithm, which uses INS and wheel speed as inputs.

A data collection application running on the automotive HPC (e.g., controller, computer device, etc.) is in signal communication with one or more devices to access signals related to Driver Gaze and one or more sensor streams of exterior video, exterior radar, and exterior lidar. Inputs to the HPC include one or more of ego-motion of the vehicle and its error estimate, Driver Gaze Vector and its error estimate, Driver Head Position and its error estimate, sensor data streams (video, radar, and/or lidar) with estimated spatial error for radar and lidar points, latency for all input signals, and sensor extrinsic and intrinsic calibration data. Outputs of the Gaze-based sensor data compression algorithm include ROI for each individual sensor containing region of sensor data corresponding to the driver's gaze in a predetermined buffered time window prior to a Data Collection Trigger Event. The trigger event may be any event having an interest for data collection, including an emergency braking event, a collision, a driver takeover event, etc.

The described system provides substantial storage savings by using a gaze-based image compression compared to traditional compression methods. The system is configured to reduce the amount of memory required to store sensor data, particularly camera data since camera data is the highest bandwidth on typical automotive HPC designs. For example, HPC sensor setup may include five radars, one lidar, and six to eleven cameras. Radar bandwidth may be 80 Mbps, lidar bandwidth may vary from 300-900 Mbps, and an individual 8.3 Mp camera input bandwidth may be 3800 Mbps.

The system may be applied to streaming sensor data of any type, most notably radar, lidar, and camera. While radar and lidar datasets are inherently 3D in nature, the computation of the cropping ROI must also be done in three-dimensions, and thus is a slightly more complex variation. In contrast, the camera copping operation also involves a 3D to 2D projection (gaze vector projected into image space), but not the identification of a 3D cropping region that is required for radar and lidar (gaze vector projection plus a depth slice determination. Thus, the camera operation is slightly less computationally intensive than the radar and lidar cropping operation. In general, the cropping operation may be performed either before the sensor data is added to the rolling buffer, or immediately before the data is written to the flash memory.

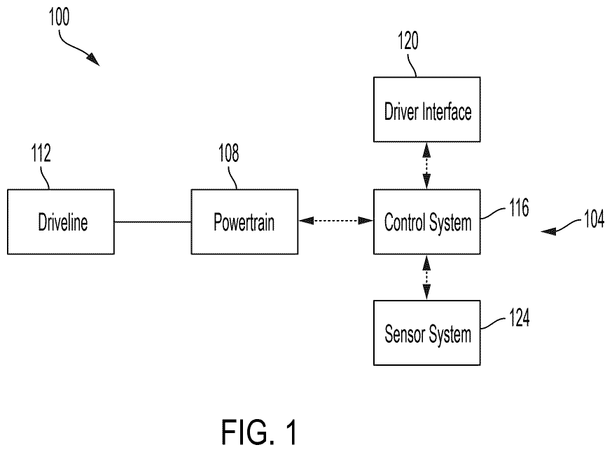

Referring now to FIG. 1, a functional block diagram of a vehicle 100 having an example data compression system 104 is illustrated. The vehicle 100 generally comprises a powertrain 108 (e.g., an engine, an electric motor, or a combination thereof) that is configured to generate and transfer torque to a driveline 112 for vehicle propulsion. A control system 116 controls operation of the vehicle 100, including primarily controlling the powertrain 108 to generate and transfer to the driveline 112 a desired amount of torque to satisfy a driver torque request. The driver torque request is received by the control system 116 from a driver interface 120, which could include an accelerator pedal and any other suitable driver input/output systems. The control system 116 is also configured to communicate with a sensor system 124, as described herein in more detail. While a single control system 116 is shown, it will be understood that control system 116 may represent a plurality of separate control systems or separate controllers (e.g., one control system for the powertrain 108 and one for the sensor system 124).

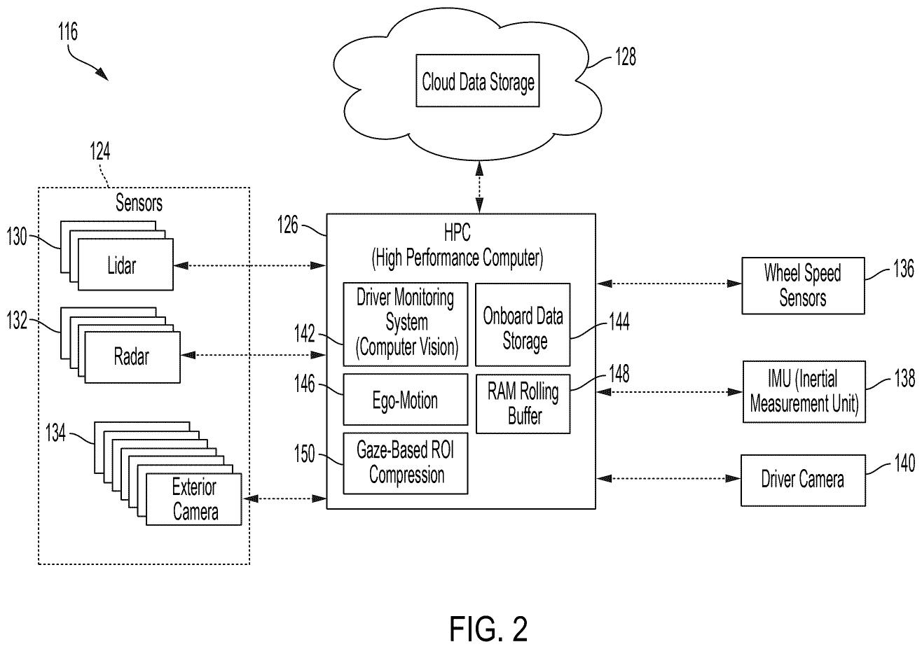

With additional reference to FIG. 2, control system 116 includes a high-performance computing device 126, which is in signal communication with the sensor system 124 and a cloud datacenter storage 128. In the example embodiment, the sensor system 124 includes one or more LIDAR sensors 130, one or more RADAR sensors 132, and one or more exterior cameras 134 that are utilized for executing one or more advanced driver assistance (ADAS) or autonomous driving features of the vehicle 100. This could include, for example only, object detection and classification in machine vision images obtained by the sensor system 124. Non-limiting examples of the autonomous driving feature(s) of the vehicle 100 include adaptive cruise control (ACC), automated lane keeping or centering, automated lane changing, and collision avoidance.

The sensor system 124 also includes one or more wheel speed sensors 136, an inertial measurement unit (IMU) 138, and a driver camera 140. In the example embodiment, the wheel speed sensors 136 are configured to provide one or more signals indicative of a speed of vehicle 100, and the IMU 138 is configured to provide one or more signals indicative of inertial movements of vehicle 100 such as, for example, yaw rate, pitch rate, acceleration, etc. The driver camera 140 is a cabin-interior camera configured to monitor a driver head position and driver gaze vector (e.g., a direction the driver is looking) and provide one or more signals indicative thereof. In one example, the driver gaze vector is calculated based on a driver monitoring algorithm that utilizes input from the driver interior camera 140.

In the example embodiment, the computing device 126 generally includes a computer vision driver monitoring system (DMS) 142, onboard data storage 144, an ego (vehicle) motion module 146, a RAM rolling buffer 148, and a gaze-based ROI compression module 150. In the example embodiment, the DMS 142 is an application that consumes interior camera video of the driver and outputs several attributes of the driver including, but not limited to, attentiveness, head position, eye position, gaze, etc. The onboard data storage 144 is memory attached to the HPC 126 that is utilized to store the ROI-cropped sensor data sequences until an opportunity is available to upload to the cloud data storage 128 (e.g., connectivity via 5G or Wi-Fi becomes available).

The ego-motion module 146, also referred to as vehicle motion module 146, is configured to determine a motion of vehicle 100. For example, vehicle velocity may be determined from wheel speed sensors 136, and yaw and pitch rates may be determined from IMU 138. The RAM rolling buffer 148 is memory configured to continuously and temporarily store sensor data from the last ‘X’ seconds (e.g., a rolling ten seconds). As new data is copied from the sensor input to the RAM rolling buffer, the oldest data is deleted on a continuous basis. When a trigger event occurs (e.g., a vehicle impact event), the data (e.g., the previous ten seconds of sensor data) from the RAM rolling buffer 148 is uploaded to the onboard data storage 144 for future analysis.

The gaze-based ROI compression module 150 is configured to reduce the amount of data stored in flash and RAM, for example, by performing 3D math and using driver gaze information to intersect with a region of the sensor system field of view, and then project that intersection point into the sensor coordinate system and use it to crop out some sensor data. In one example, the intersection of the gaze vector with the sensor data defines a center of the cropping ROI itself, but the size of the ROI (either expressed in angular azimuth and elevation range or horizontal and vertical pixels) is variable based on system design (e.g., user-configurable data cropping size that is expanded by an error estimation).

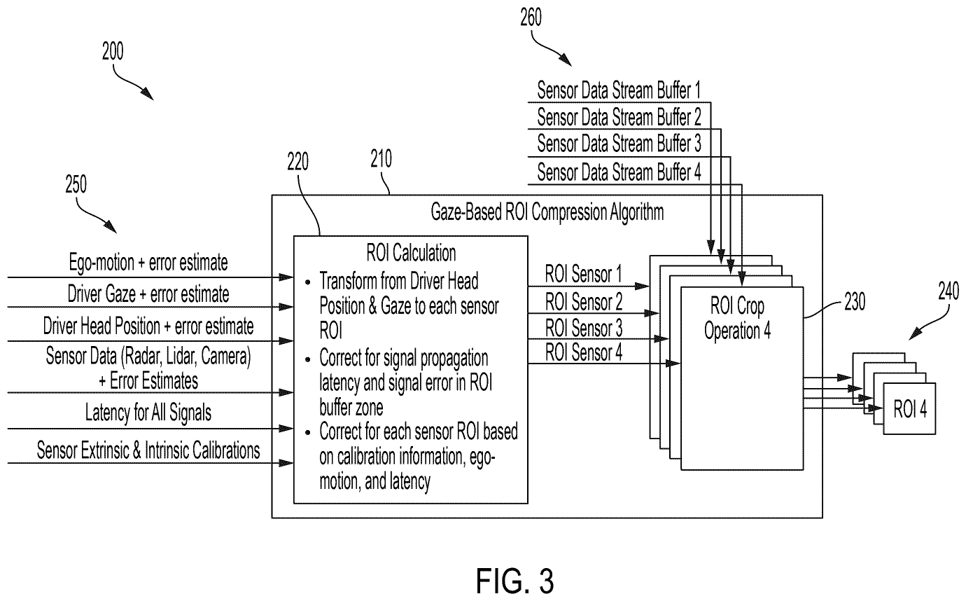

Referring now to FIG. 3, a schematic diagram 200 of an example operation of the gaze-based ROI compression algorithm 210 is illustrated. In the example embodiment, the gaze-based ROI compression algorithm 210 generally includes a ROI calculation operation 220 and a ROI crop operation 230 to provide a ROI data output 240.

As illustrated, the ROI calculation operation 220 begins with receiving input 250 from the control system 116 and/or the sensor system 120. In the example embodiment, input 250 includes: (i) Ego-motion data and an error estimate, which estimate how the vehicle is moving over time. The error estimate establishes a buffer region to account for inaccuracies in measurement when subsequently cropping the ROI. For example, vehicle velocity has an associated error, so the system calculates a minimum and maximum cropping region based on the error; (ii) Driver gaze data and an error estimate. This includes a driver gaze vector, which provides a direction of driver vision; (iii) Driver head position data and an error estimate. This includes a driver head position, which indicates a point in 3D space from which the gaze vector initiates. This is used to calculate the intersection of the gaze vector with the sensor region in 3D space; (iv) Sensor data (e.g., radar, lidar, camera) and error estimates; (v) Latency data for all input signals. This allows the system to map the ego motion data, drive gaze data, and head position data to the correct timestamp of the sensor signal/data to be cropped; and (vi) Sensor extrinsic and intrinsic calibrations. Extrinsic calibration data provides the locating of the sensors in 3D space relative to the driver gaze vector. Intrinsic calibration data corrects for distortion (e.g., lens distortion).

The ROI calculation operation 220 generally includes receiving the input data 250, and subsequently transforming from the driver head position and driver gaze to each sensor ROI. In one example, each sensor ROI is the intersection of the gaze vector with a plane (in the case of an image) or, for radar and lidar, the intersection of the gaze vector with a 3D shape yields a line segment. Application of the tolerances around that line segment will yield a cylinder (in the case of constant errors), or a cone (in the case of linear varying errors). The operation then corrects for signal propagation latency and signal error in the ROI buffer zone, for example, based on the signal latency and error estimates. The operation then corrects for each sensor ROI, for example, based on calibration information, ego-motion, and signal latency. The ROI calculation operation 220 provides one or more ROI for each sensor used in the data capture (four shown).

The ROI crop operation 230 begins with the sensor ROI (“ROI sensor x”) from ROI calculation 220, and sensor data stream buffers 260 from the RAM rolling buffer 148. In the example embodiment, the “sensor data stream buffer x” is the data for each sensor stored in the RAM rolling buffer 148 for the predetermined buffer time (e.g., ten seconds) prior to the triggering event. The ROI data is then cropped based on the intersection of the driver gaze with the sensor ROI. In other words, the driver gaze vector is considered the most relevant area for data related to the triggering event (e.g., vehicle impact, driver takeover) since the driver will tend to be looking at the reason for the triggering event. Accordingly, the computing device 126 performs a 3D cropping operation on data from multiple sensors, leveraging time and motion information and driver gaze throughout the scene. In this way, the ROI data output 240 for each individual sensor corresponds to the driver's gaze in the buffered time window.

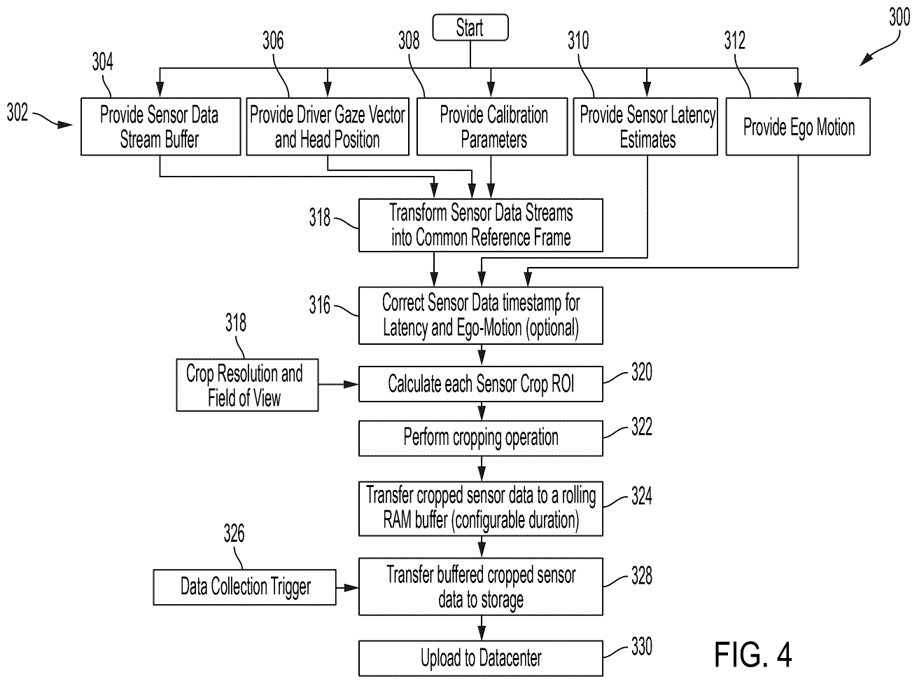

Referring now to FIG. 4, a flow diagram of an example method 300 for vehicle data compression is illustrated. While the vehicle 100 and its components are specifically discussed for descriptive/illustrative purposes, it will be appreciated that the method 300 could be applicable to any suitable vehicle. The method begins at 302 where the control system 116 or other controller such as computing device 126 (“control”) provides (or receives) information for the vehicle data compression. This information may be provided simultaneously or in any suitable order.

For example, the provided/received information includes a sensor data stream buffer 304, driver gaze vector and head position 306, sensor extrinsic and intrinsic calibration parameters 308, sensor latency estimates 310, and ego (vehicle) motion 312.

At 314, control utilizes the information from 304, 306, 308 to transform the sensor data streams into a common reference frame. In one example, this involves applying to each sensor including the DMS 142, a 4D transformation matrix representing the translation and rotation from each individual sensor coordinate system to the common (vehicle) coordinate system. As such, scene data from different sensors (cameras, radar, and lidar) are combined from different instants in time by transforming the recordings with sensor calibrations and the ego motion data. At optional step 316, control utilizes information from 310, 312, 314 to correct sensor data timestamps for latency and ego-motion.

At 318, control crops the resolution and field of view for each sensor. At 320, control calculates a sensor crop ROI for each sensor based on the driver gaze vector and head position for each time stamp within the sensor data stream buffer. At 322, control performs the cropping operation for each sensor ROI. At 324, control transfers the cropped sensor data to the rolling RAM buffer 148. At 326, a triggering data collection event occurs. At 328, control transfers the buffered cropped sensor data from the rolling RAM buffer 148 to the onboard data storage 144. At 330, control uploads the buffered cropped sensor data from the onboard data storage 144 to the datacenter 128. The method 300 then ends for returns to 302 for one or more additional cycles.

It will be appreciated that the terms “controller” or “control system” or “module” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present disclosure, its application or uses. Thus, variations that do not depart from the gist of the present disclosure are intended to be within the scope of the present disclosure.

What is claimed is:

1. A vehicle, comprising:
a sensor system including one or more individual sensors configured to capture sensor data;
a driver camera configured to monitor a driver head position and a driver gaze vector indicating a direction of driver vision; and
a data compression system including a computing device having one or more processors and a non-transitory computer-readable storage medium having a plurality of instructions stored thereon, which, when executed by the one or more processors, cause the one or more processors to perform operations comprising:
receiving sensor data from each individual sensor;
determining, by the driver camera, an instantaneous driver head position and driver gaze vector;
determining, for each individual sensor, a region of interest (ROI) of the sensor data based on the instantaneous driver head position and driver gaze vector; and
cropping the ROI for each individual sensor based on an intersection of the driver gaze vector with the determined ROI to thereby provide cropped sensor data with a reduced amount of sensor data from each individual sensor.

2. The vehicle of claim 1, wherein the intersection of the driver gaze vector with the determined ROI defines a center of the determined ROI, and cropping the ROI is based on a user-configurable data cropping size that is expanded by an error estimation.

3. The vehicle of claim 1, wherein the computing device further performs operations comprising:
transferring the cropped sensor data for each individual sensor to a rolling RAM buffer.

4. The vehicle of claim 3, wherein the computing device further performs operations comprising:
identifying a data capture trigger event; and
transferring the cropped sensor data for each individual sensor from the rolling RAM buffer to an onboard data storage device for further analysis of the data capture trigger event.

5. The vehicle of claim 4, wherein the computing device further performs operations comprising:
uploading the cropped sensor data from the onboard data storage device to a networked data center for further analysis of the data capture trigger event.

6. The vehicle of claim 4, wherein the data capture trigger event is a driver takeover from an advanced driver assist system (ADAS) or an autonomous driving system.

7. The vehicle of claim 1, wherein the one or more individual sensors comprises each of:
one or more exterior cameras configured for machine vision functionality;
one or more radar sensors; and
one or more lidar sensors.

8. The vehicle of claim 1, wherein the computing device further performs operations comprising:
correcting the sensor data from each individual sensor utilizing extrinsic and intrinsic calibration information.

9. The vehicle of claim 1, wherein the computing device further performs operations comprising:
correcting sensor data time stamps from each individual sensor based on sensor latency estimates.

10. The vehicle of claim 1, wherein the computing device further performs operations comprising:
correcting sensor data time stamps from each individual sensor based on one or more signals from a vehicle motion module configured to detect vehicle motion.

11. A computer-implemented method for data compression in a vehicle having a sensor system including one or more individual sensors configured to capture sensor data, a driver camera configured to monitor a driver head position and a driver gaze vector indicating a direction of driver vision, and a data compression system including a computing device having one or more processors, the method comprising:
receiving, at the computing device, sensor data from each individual sensor;
determining, by the computing device and the driver camera, an instantaneous driver head position and driver gaze vector;
determining, by the computing device, for each individual sensor, a region of interest (ROI) of the sensor data based on the instantaneous driver head position and driver gaze vector; and
cropping, by the computing device, the ROI for each individual sensor based on an intersection of the driver gaze vector with the determined ROI to thereby provide cropped sensor data with a reduced amount of sensor data from each individual sensor.

12. The method of claim 11, wherein the intersection of the driver gaze vector with the determined ROI defines a center of the determined ROI, and cropping the ROI is based on a user-configurable data cropping size that is expanded by an error estimation.

13. The method of claim 11, further comprising transferring, by the computing device, the cropped sensor data for each individual sensor to a rolling RAM buffer.

14. The method of claim 13, further comprising:
identifying a data capture trigger event; and
transferring, by the computing device, the cropped sensor data for each individual sensor from the rolling RAM buffer to an onboard data storage device for further analysis of the data capture trigger event.

15. The method of claim 14, further comprising uploading, by the computing device, the cropped sensor data from the onboard data storage device to a networked data center for further analysis of the data capture trigger event.

16. The method of claim 14, wherein the data capture trigger event is a driver takeover from an advanced driver assist system (ADAS) or an autonomous driving system.

17. The method of claim 11, wherein the one or more individual sensors comprises each of:
one or more exterior cameras configured for machine vision functionality;
one or more radar sensors; and
one or more lidar sensors.

18. The method of claim 11, further comprising correcting, by the computing device, the sensor data from each individual sensor utilizing extrinsic and intrinsic calibration information.

19. The method of claim 11, further comprising correcting, by the computing device, sensor data time stamps from each individual sensor based on sensor latency estimates.

20. The method of claim 11, further comprising correcting, by the computing device, sensor data time stamps from each individual sensor based on one or more signals from a vehicle motion module configured to detect motion of the vehicle.
